(19) United States
(12) Patent Application Publication
(10) Pub. No.: US 2025/0262627 A1
(43) Pub. Date: Aug. 21, 2025

(54) WATER OUTLET STRUCTURE

(71) Applicant: Xiamen Water Nymph Sanitary Technology Co., Ltd., Xiamen (CN)

(72) Inventors: Huaqiang ZHOU, Xiamen (CN); Tianming WANG, Xiamen (CN); Peng XIE, Xiamen (CN)

(73) Assignee: Xiamen Water Nymph Sanitary Technology Co., Ltd., Xiamen (CN)

(21) Appl. No.: 19/204,364

(22) Filed: May 9, 2025

Related U.S. Application Data
(63) Continuation of application No. PCT/CN2023/130093, filed on Nov. 7, 2023.

(30) Foreign Application Priority Data
Nov. 11, 2022 (CN) 202211414073.6
Nov. 11, 2022 (CN) 202223015732.7

(51) Int. Cl. B05B 1/14

(52) U.S. Cl. CPC B05B 1/14

(57) ABSTRACT

A water outlet structure includes a water inlet and a water outlet in communication. The water inlet is provided with a plurality of water inlet openings, the water outlet is provided with a plurality of water outlet openings, and the sum of the areas of each of the water outlet openings is greater than the sum of the areas of each of the water inlet openings. The present disclosure can form a dense water column with abundant flow volume and smooth water-air mixed flow, which is not prone to splashing when acting on cleaning surfaces, thereby providing excellent user experience.

### CROSS-REFERENCE TO RELATED APPLICATIONS

This application is a continuation application of International Application No. PCT/CN2023/130093, filed on Nov. 7, 2023, which claims priority to Chinese Application No. 202211414073.6, filed on Nov. 11, 2022, and Chinese Application No. 202223015732.7, filed on Nov. 11, 2022. The disclosures of the above-mentioned applications are hereby incorporated by reference in their entireties.

### TECHNICAL FIELD

The present disclosure relates to the field of sanitary ware and, more particularly, to a water outlet structure.

### BACKGROUND

To enhance the water outlet effect of terminal water outlet devices (including products such as showers and aerators) under low or normal water pressure supply conditions, the prior art generally adopts the approach of reducing the aperture size of individual water outlet hole apertures on the water outlet panel of the terminal water outlet device. For example, a thin steel sheet may be used as the water outlet panel, forming hundreds of water outlet holes with apertures of from 0.3 to 0.5 mm on the water outlet panel. Such a structure allows water to enter the water containment chamber upstream of the water outlet panel. During the process where the water body penetrates the aforementioned apertured water outlet holes as a whole, the water body is compressed within the water outlet holes, thereby increasing the internal pressure of the water body, which enables the water flow to exhibit greater pressure after reaching the downstream side of the water outlet panel, significantly increasing the jet distance and consequently improving the water outlet effect.

### SUMMARY

The present disclosure is to provide a water outlet structure and a water outlet panel to achieve the pressurized water outlet under the premise of ensuring the normal use of the suction water-saving function of the water outlet device.

In some embodiments, the disclosure includes a water outlet structure, including a water inlet and a water outlet in communication. The water inlet is provided with a plurality of water inlet openings, the water outlet is provided with a plurality of water outlet openings, and the sum of the areas of each of the water outlet openings is greater than the sum of the areas of each of the water inlet openings.

In some embodiments, the disclosure includes an aerator which has a water outlet side provided with the water outlet structure according to the above embodiments.

According to the embodiments of the disclosure, different from the prior art, in the water outlet structure of his disclosure, after water flow penetrates through the water inlet opening, a negative pressure is generated on the outlet side of the water inlet opening, causing air from the external space of the water outlet structure to be drawn into the water inlet opening, thereby enabling thorough mixing of water and air. In some embodiments, since the total area of all water outlet openings is greater than the total area of the water inlet openings, that is, the total inlet area of the chamber is smaller than its total outlet area, the aforementioned air-water mixed flow is less likely to create pressure accumulation that would cause water to overflow through other passages or openings connected to the outlet side of the water inlet openings and discharge into the external space of the water outlet structure. Based on the above description, each column of discharged water flow ejected from the water outlet structure has undergone acceleration through the water outlet openings and contains mixed air, which provides the following advantages: On one hand, the discharged water flow contains air which achieves water-saving effects while still maintaining high water volume density and considerable jet distance; on the other hand, the air-mixed discharged water flow provides a softer tactile sensation and creates significantly less splashing when impacting surfaces of cleaned objects. When the water outlet structure of this solution is applied to bubble generators, it proves particularly suitable for use scenarios requiring limited water splashing, such as vegetable washing sinks and hand washing basins.

### BRIEF DESCRIPTION OF THE DRAWINGS

FIG. 1 is an exploded view of a water outlet structure according to some embodiments of the present disclosure.

FIG. 2 is a sectional view of a water outlet structure according to some embodiments of the present disclosure.

FIG. 3 is an exploded view of a water outlet structure according to some embodiments of the present disclosure.

FIG. 4 is a sectional view of a water outlet structure according to some embodiments of the present disclosure.

FIG. 5 is an exploded view of an aerator according to some embodiments of the present disclosure.

FIG. 6 is a sectional view of an aerator according to some embodiments of the present disclosure.

FIG. 7 is a partially enlarged perspective view of a water inlet side of a water outlet panel according to some embodiments of the present disclosure.

FIG. 8 is a partially enlarged view at A in FIG. 4.

FIG. 9 is a partially enlarged perspective sectional view of a water inlet side of a water outlet panel according to some embodiments of the present disclosure.

### DETAILED DESCRIPTION OF THE EMBODIMENTS

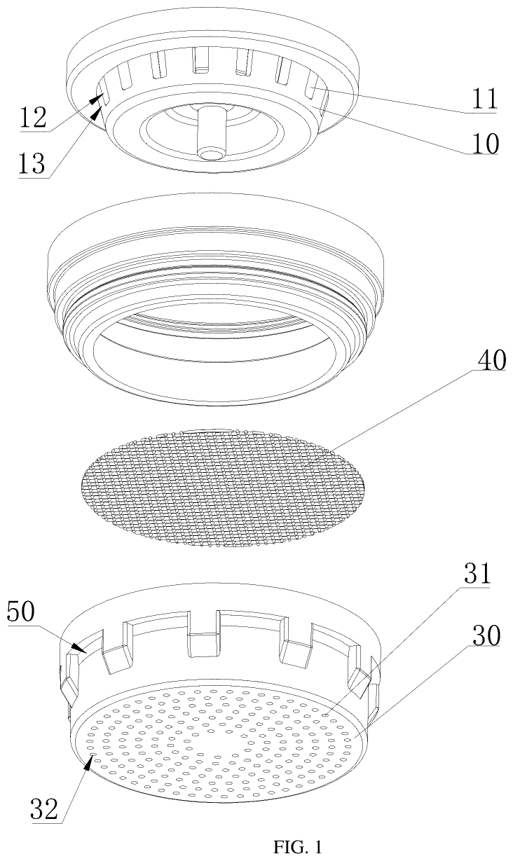

In some embodiments of the disclosure, referring to FIGS. 1-6, respectively, a water outlet structure includes a water inlet and a water outlet in communication. The water inlet is provided with a plurality of water inlet openings, the water outlet is provided with a plurality of water outlet openings, the sum of the areas of each of the water outlet openings is greater than the sum of the areas of each of the water inlet openings.

Referring to FIGS. 1-6, respectively, a water outlet structure 100 includes a jet panel 10, a chamber 20 and a water outlet panel 30, the jet panel 10 is provided with a plurality of jet holes 11, a water outlet side 12 of the jet holes 11 communicates with the chamber 20, a space of one side of the chamber 20 facing the water outlet direction is defined by the water outlet panel 30, and the water outlet panel 30 is provided with a plurality of water outlet holes 31, where the water outlet side 12 of the jet holes 11 do not pass through the chamber 20 and can communicate with an outer space of the water outlet structure 100, and a sum of opening (i.e., water outlet opening) areas of each water outlet hole 31 on the water outlet side 32 surface of the water outlet panel is greater than a sum of opening (i.e., water inlet opening) areas of all the jet holes 11 on the water outlet side 13 surface of the jet panel, and the area of a single water outlet hole 31 on the water outlet side 32 surface of the water outlet panel is from 0.04 mm² to 0.3 mm².

The working principle of the present disclosure is that: a water outlet panel structure and an air suction structure with a small hole with a water outlet opening area of from 0.04 mm² to 0.3 mm² are combined, after the water flow penetrates the jet panel from the jet hole 11, a negative pressure is generated on the water outlet side of the jet hole; the air in the outer space of the water outlet structure 100 is adsorbed to the water outlet side of the jet hole, and the water flow and the air can be sufficiently mixed in a chamber with a limited space, the aforementioned air suction structure refers to an air intake channel connected to the external space of the water outlet structure 100. This air intake channel enables the outlet side of the jet hole to directly communicate with the external space through the air intake channel without passing through the chamber, thereby ensuring smooth air suction; since the sum of the opening areas of all the water outlet holes on the water outlet panel on the water outlet side surface of the water outlet panel is greater than the sum of the opening areas of all the jet holes on the jet panel on the water outlet side surface of the jet panel, i.e., the total water inlet area of the chamber is smaller than the total water outlet area of the chamber, the aforementioned water flow after gas-water mixing cannot easily generate pressure aggregation in the chamber, resulting in the water flow overflowing from other passages or openings which can be connected to the water outlet side of the jet holes and flowing to the outer space of the water outlet structure 100, and each column of water exiting flow out of the water outlet structure 100 from the small holes of the water outlet panel is accelerated by passing through the water outlet holes and mixed with air.

According to some embodiments of the disclosure: on one hand, air is mixed in the exiting water flow from the water outlet structure 100 and can save water, and the exiting water flow can still have a higher plumpness and a longer spraying distance by means of dense and fine water outlet holes, on the other hand, compared with the existing dense small hole water outlet structure 100 without air suction function, the exiting water flow mixed with air has a softer touch and produces less splash when it acts on the surface of an object to be cleaned.

In some embodiments, the sum of the opening areas of all the water outlet holes 31 on the water outlet side 32 surface of the water outlet panel is greater than or equal to twice the sum of the opening areas of all the jet holes 11 on the water outlet side 13 surface of the jet panel.

It can be understood that setting the total water outlet area of the chamber to be twice or more than twice the total water inlet area can further reduce the probability of pressure aggregation caused by water flow in the chamber, which ensures that the water flow will not overflow and cause cross-flow issues, while simultaneously guaranteeing that gas can be smoothly drawn to the water outlet side of the jet panel to mix with the water flow.

In some embodiments, the opening area of each water outlet hole 31 on the water inlet side 33 surface of the water outlet panel is greater than the opening area of any of the water outlet holes 31 on the water outlet side 32 surface of the water outlet panel.

The inlet area of the water outlet hole being greater than the outlet area can ensure that a side wall of the water outlet hole has a certain slope, and shrinks from the water inlet side to the water outlet side, which ensures that the water flow can smoothly accelerate out of the water outlet hole, and the water inlet side opening area of the water outlet hole being greater than the water outlet side opening area can ensure that a partition wall between adjacent water outlet holes expands from the inlet direction to the outlet direction, on one hand, ensuring that the hole spacing of the water outlet hole on the water outlet side is sufficiently large, avoiding the water outlet water column from adhering, and on the other hand, ensuring that the water-facing area of the water inlet side of the water outlet panel is sufficiently small, the resistance of the water flow in the chamber to enter the water outlet hole is reduced, and the pressure aggregation of the water flow in the chamber is avoided.

In some embodiments, an opening shape of the water outlet hole 31 on the water inlet side 33 surface of the water outlet panel is a triangle or another polygon.

With the opening shape of the water outlet hole on the water inlet side of the water outlet panel being set as a triangle or a polygon, the area of the water inlet side surface is more effectively used to arrange the water inlet openings of the water outlet holes, and increase the arrangement density of the water outlet holes.

In some embodiments, the opening shape of the water outlet hole 31 on the water outlet side 32 surface of the water outlet panel is a circle, an ellipse, a triangle or another polygon.

Unlike the opening shape of the water outlet hole on the water inlet side of the water outlet panel which must consider arrangement density issues, the opening shape of the water outlet hole on the water outlet side of the water outlet panel can be set according to the actual requirements for the shape of the water flower, and a circular hole, an elliptical hole and a triangular row of holes can output a columnar water flow, and a polygonal hole can also output a sheet-shaped water flow.

In some embodiments, referring to the enlarged view of the water outlet panel of FIG. 8, an axial height distance H of the water outlet hole 31 is greater than a perimeter of an opening profile of the water outlet hole 31 on the water outlet side 32 surface of the water outlet panel.

The water outlet hole needs to have a certain stroke length (i.e., the distance through which the exiting water flow completely enters the water outlet hole to completely leaves the water outlet hole) so as to adjust the exiting direction and jet velocity of the exiting water flow, thereby ensuring that the finally formed water shape meets the requirements; for the forming of water pattern, the perimeter of the opening on the water outlet side of the water outlet panel is a key influencing factor.

By correlating the axial height distance of the water outlet holes with the perimeter of the opening profile on the water outlet side surface of the water outlet panel, the purpose of ensuring water pattern formation can be achieved. In particular, when the axial height distance H of the water outlet holes is set to be greater than or equal to 1.5 times the perimeter of the opening profile on the water outlet side surface of the water outlet panel, the most stable water pattern can be obtained. It should be noted that, when the water inlet side surface of the water outlet panel is not parallel to the water outlet side surface, the axial height distance H of the water outlet hole is a length size from a start point at which the water column of the water flow completely enters the water outlet hole to a start point at which the water column of the water flow completely leaves the water outlet hole to an end point.

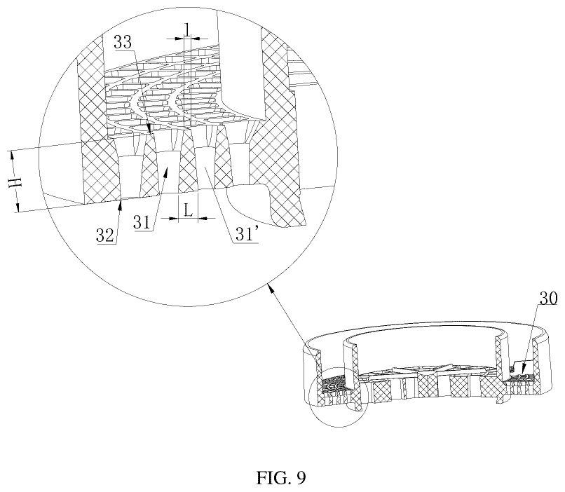

In some embodiments, referring to the enlarged views of the water outlet panel of FIGS. 8 and 9, a minimum separation distance L between openings of any two adjacent water outlet holes 31, 31′ on the water outlet side 32 surface of the water outlet panel is greater than a diameter of a maximum inscribed circle of the opening profiles of these two water outlet holes 31, 31′ on the water outlet side 32 surface of the water outlet panel.

By providing such a dimensional proportion relationship, it is possible to avoid blocking of the water outlet water column. Here, the diameter of the maximum inscribed circle of the opening profile can be considered to be the size where the opening is widest, and the diameter of the maximum inscribed circle of the opening profile in FIGS. 8 and 9 is the diameter of the opening. In addition, when the ratio is greater than or equal to 1.5:1, a better balance can be obtained in the water outlet effect, the water outlet hole density and the water outlet hole aperture.

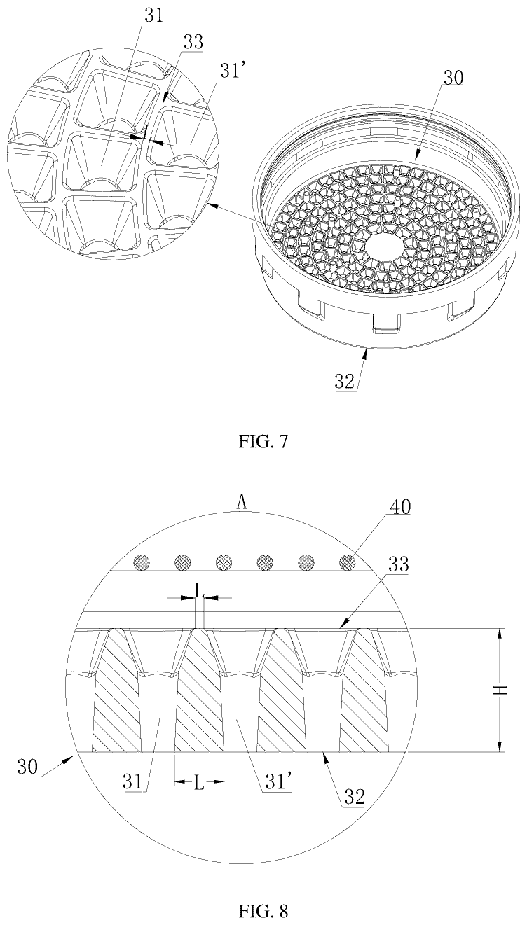

In some embodiments, referring to the enlarged views of the water outlet panel in FIGS. 7-9, a minimum separation distance L between openings of any two adjacent water outlet holes 31, 31′ on the water inlet side 33 surface of the water outlet panel is smaller than a diameter of a minimum inscribed circle of the opening profiles of these two water outlet holes 31, 31′ on the water outlet side 32 surface of the water outlet panel.

By providing such a size-proportion relationship, it can be ensured that the water-facing area of the water inlet side of the water outlet panel is sufficiently small, the resistance to the water flow in the chamber entering the water outlet hole is reduced, and the pressure aggregation of the water flow in the chamber is avoided. Here, the diameter of the minimum inscribed circle of the opening profile can be considered to be the size where the opening is narrowest, and the diameter of the minimum inscribed circle of the opening profile in FIGS. 7-9 is the diameter of the opening. In addition, when the ratio is smaller than or equal to 0.5:1, a better balance can be obtained in the drainage speed, the water outlet hole density and the water outlet hole aperture.

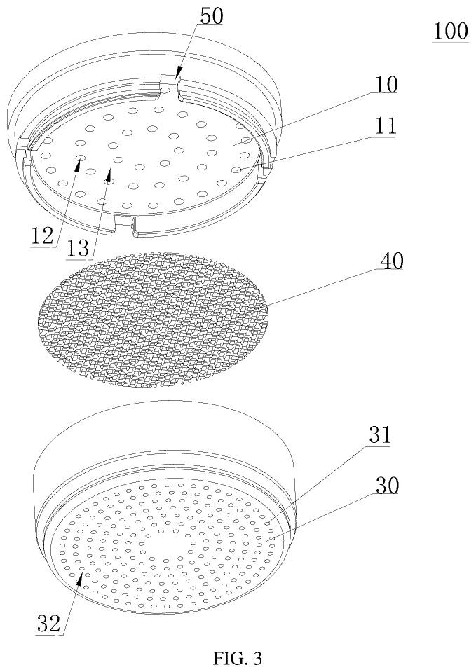

In some embodiments, as shown in FIG. 1 or 3, a screen mesh 40 is further included and provided on the water inlet side 33 of the water outlet panel, where the screen mesh 40 is spaced apart from the water outlet panel 30, and the screen mesh 40 has a single mesh area smaller than the area of the opening profile of the water outlet hole 31 on the water outlet side 32 surface of the water outlet panel.

The screen mesh can screen the relatively large impurities, so as to avoid the impurities blocking the water outlet hole, thus preventing the water outlet hole from discharging water or affecting the emitting angle of the exiting water flow.

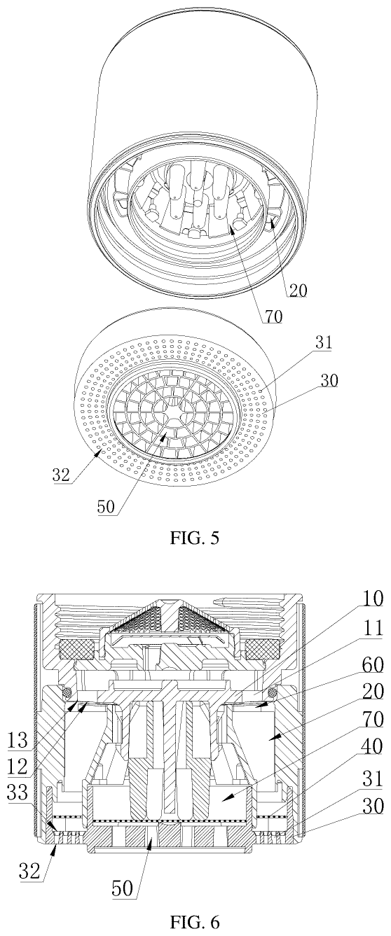

In some embodiments, as shown in connection with FIGS. 5 and 6, the water outlet side 12 of the jet hole communicates with an outer space of the water outlet structure 100 via an air inlet 50 on the same side of the water outlet panel 30, i.e., the air inlet opening 50 is located on the water outlet side of the water outlet panel 30, that is to say, the air inlet opening 50 and the water outlet side of the water outlet panel 30 are located on the same side.

This solution is applicable to a water outlet structure 100 having two independent water outlet channels, where the additional water outlet channels communicate with the outer space of the water outlet structure 100, the water inlets of the two water outlet channels communicate with each other, and the water inlets of the two water outlet channels can be selectively connected to the jet holes on the jet panel by rotating relative to the jet panel, so that it can be achieved that the water outlet panel having a water outlet opening area of from 0.04 mm² to 0.3 mm² can suck air from the additional water outlet channels when water is discharged (the water outlet channels corresponding thereto are in a water-passing state).

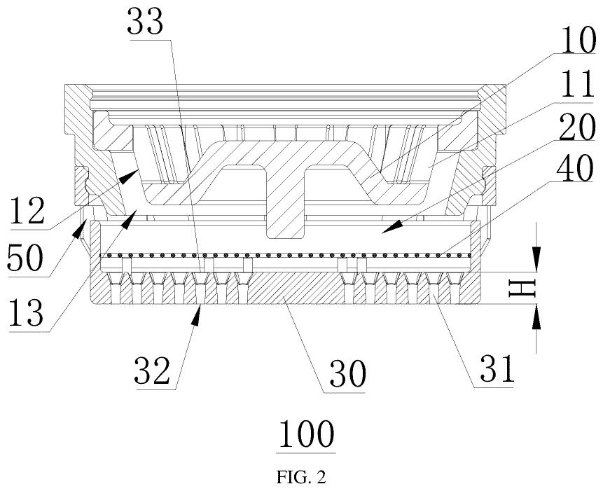

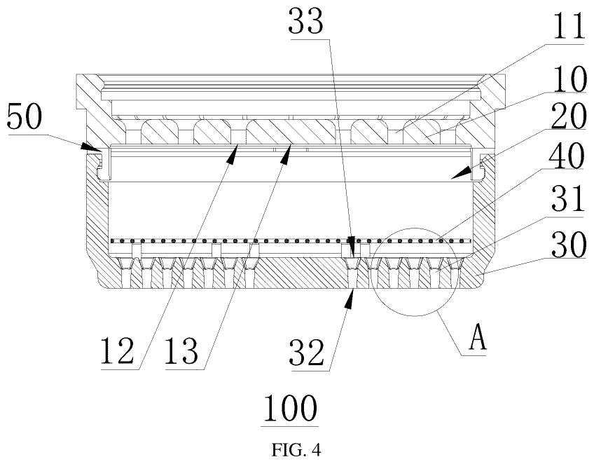

In some embodiments, in connection with FIGS. 1 and 2, and in connection with FIGS. 3 and 4, the water outlet side 12 of the jet hole communicates with the outer space of the outlet structure via an air inlet 50 which opens into the side wall of the water outlet structure 100.

The structure of the above embodiment is relatively simple, the communication distance between the water outlet side of the jet hole and the outer space of the water outlet structure 100 is very short, and the air in the outer space can easily reach the water outlet side of the jet hole to mix with the jet. The solution of FIGS. 1 and 2 differs from the solution of FIGS. 3 and 4 in that the jet holes of the solution of FIGS. 1 and 2 are provided on a side wall surface of the jet panel, and the opening profile of the jet holes on the water outlet side of the jet panel is strip-shaped, while the jet holes of the solution of FIGS. 3 and 4 are provided on the bottom surface of the jet panel, and the opening profile of the jet holes on the water outlet side of the jet panel is circular.

As shown in FIGS. 1 to 6, the aforementioned embodiment can be applied to the aerator structure. In addition, in other adaptation scenarios not illustrated by the figures, the aforementioned solution can also be applied in a shower structure.

When the water outlet structure 100 of the above embodiment is applied to a small-sized aerator, it is very suitable for use scenarios that need to limit the degree of splashing in a vegetable washing pool, a hand washing pool and the like; when the water outlet structure 100 of the present embodiment is applied to the shower, the water outlet of the shower can be made more gentle and the user's bath comfort can be improved.

Some embodiments of the present disclosure are as follows: a water outlet structure 100 includes a water outlet panel 30, a water outlet panel 30 is provided with a plurality of water outlet holes 31, where an opening area of the water outlet holes 31 on the water inlet side 33 surface of the water outlet panel is greater than the opening area of the water outlet holes 31 on a water outlet side 32 surface of the water outlet panel, a minimum separation distance L between the openings of any two adjacent water outlet holes 31, 31′ on the water inlet side 33 surface of the water outlet panel is smaller than the diameter of a minimum inscribed circle of an opening profile of the two water outlet holes 31, 31′ on the water outlet side 32 surface of the water outlet panel; and the area of a single water outlet hole 31 on the water outlet side 32 surface of the water outlet panel is from 0.04 mm²-0.3 mm².

The working principle of the aforementioned embodiment is as follows: the inlet area of the water outlet hole being greater than the outlet area can ensure that an inner wall of the water outlet hole has a certain slope, and shrinks from the water inlet side to the water outlet side, which ensures that the water flow can smoothly accelerate out of the water outlet hole, and the water inlet side opening area of the water outlet hole being greater than the water outlet side opening area can ensure that a partition wall between adjacent water outlet holes expands from the inlet direction to the outlet direction, ensuring that the hole spacing of the water outlet hole on the water outlet side is sufficiently large, avoiding the water outlet water column from adhering, and on the other hand, ensuring that the water-facing area of the water inlet side of the water outlet panel is sufficiently small, the resistance of the water flow in the chamber to enter the water outlet hole is reduced, and the pressure aggregation of the water flow in the chamber is avoided; meanwhile, since a minimum separation distance between the openings of any two adjacent water outlet holes on the water inlet side surface of the water outlet panel is smaller than the diameter of a minimum inscribed circle of an opening profile of the two water outlet holes on the water outlet side surface of the water outlet panel, this feature creates a water outlet hole configuration that further allows the water-facing area of the water inlet side of the water outlet panel to be sufficiently small that the resistance to water flow entering the water outlet hole from the water outlet panel is reduced.

The aforementioned embodiment ensures that the water flow can be smoothly emitted outwards through the water outlet panel, and avoids the problem of the water flow overflowing from other gaps or channels in the structure due to the pressure aggregation in the water flow which is easily generated in a chamber upstream of the water outlet panel during the water flowing.

In some embodiments, as shown in FIGS. 4 and 6, what is in the aforementioned structures can all be installed on the water outlet side of the aerator. In addition, in other adaptation scenarios not illustrated by the figures, the aforementioned structures can also be applied on a shower for use as a water outlet panel of the shower.

Referring to FIGS. 1, 2 and 7, some embodiments of the present disclosure are as follows: a water outlet structure 100 for use in a single water outlet channel aerator includes a jet panel 10, a chamber 20, a water outlet panel 30 and a screen mesh 40.

A plurality of jet holes 11 are provided on the jet panel 10 and are provided on a side wall surface of the jet panel 10, the opening profile of the water outlet side 12 of the jet holes is strip-shaped, the water outlet side 12 of the jet holes communicates with the chamber 20, and meanwhile, the water outlet side 12 of the jet hole communicates with the outer space of the water outlet structure 100 through an air inlet port 50 whose opening is located on the side wall of the water outlet structure 100.

The space of one side of the chamber 20 facing the water outlet direction is defined by the water outlet panel 30; the screen mesh 40 is provided in the chamber 20, that is to say, the screen mesh 40 is provided on the water inlet side 33 of the water outlet panel, and the screen mesh 40 covers the whole water inlet side 33 of the water outlet panel; and the screen mesh 40 is provided at a spacing from the water outlet panel 30 via a raised support body on the water inlet side 33 of the water outlet panel.

A plurality of water outlet holes 31 are provided on the water outlet panel 30; the area of a single water outlet hole 31 on the water outlet side 32 surface of the water outlet panel is 0.096 mm², 0.126 mm², 0.159 mm², 0.196 mm², 0.237 mm² or 0.282 mm²; the sum of the opening areas of all the water outlet holes 31 on the water outlet side 32 surface of the water outlet panel is 2 times, 2.1 times, 2.2 times, 2.3 times, 2.4 times, 2.5 times, 2.6 times, 2.7 times, 2.5 times or 3 times the sum of the opening areas of all the jet holes 11 on the water outlet side 13 surface of the jet panel; the area of a single mesh of the screen mesh 40 is smaller than the area of the opening profile of the water outlet holes 31 on the water outlet side 32 surface of the water outlet panel.

The opening area of the single water outlet hole 31 on the water inlet side 33 surface of the water outlet panel is greater than the opening area of the single water outlet hole 31 on the water outlet side 32 surface of the water outlet panel so as to form an upper, larger and lower, smaller and shrink-shaped opening shape, the opening shape of the water outlet hole 31 on the water inlet side 33 surface of the water outlet panel is a quadrangle, and the opening shape of the water outlet hole 31 on the water outlet side 32 surface of the water outlet panel is a circle.

The axial height distance H of the water outlet hole 31 is greater than the perimeter of the opening profile of the water outlet hole 31 on the water outlet side 32 surface of the water outlet panel; in some embodiments, the same side hole dimensions of all the water outlet holes 31 are equal; the openings of the water inlet side 33 surface of the water outlet panel are arranged in a staggered manner; the minimum separation distance L between the openings of any two adjacent water outlet holes 31, 31′ on the water outlet side 32 surface of the water outlet panel is greater than the diameter of the maximum inscribed circle of the opening profile of the two water outlet holes 31, 31′ on the water outlet side 32 surface of the water outlet panel; and the minimum separation distance L between the openings of any two adjacent water outlet holes 31, 31′ on the water inlet side 33 surface of the water outlet panel is smaller than the diameter of the minimum inscribed circle of the opening profile of these two water outlet holes 31, 31′ on the water outlet side 32 surface of the water outlet panel.

Referring to FIGS. 3, 4 and 8, some other embodiments of the present disclosure are as follows.

The jet holes 11 are provided on the bottom surface of the jet panel 10, and the opening profile of the water outlet side 12 of the jet hole is circular; the area of a single water outlet hole 31 on the water outlet side 32 surface of the water outlet panel is 0.13 mm², the sum of the opening areas of all the water outlet holes 31 on the water outlet side 32 surface of the water outlet panel is 2.5 times the sum of the opening areas of all the jet holes 11 on the water outlet side 13 surface of the jet panel, the sizes of the openings of all the water outlet holes 31 on the water inlet side 33 surface of the water outlet panel are not all equal, and the openings of the water inlet side 33 surface of the water outlet panel are arranged in alignment.

According to some embodiments of the present disclosure, referring to FIGS. 5, 6 and 9, the water outlet structure 100 and the water outlet panel 30 are applied to an aerator with multiple water outlet channels, the jet holes 11 are provided on the bottom surface of a jet panel 10, and an opening profile of a water outlet side 12 of the jet hole is strip-shaped; the areas of the surfaces of a single water outlet hole 31 on the water outlet side 32 surface of the water outlet panel are of different sizes, for example the sizes of 0.096 mm², 0.126 mm², 0.159 mm², 0.196 mm², 0.237 mm², 0.282 mm², etc. can be selected, the sum of the opening areas of the surfaces of all the water outlet holes 31 on the water outlet side 32 surface of the water outlet panel is 3 times the sum of the opening areas of the all the jet holes 11 on the water outlet side 13 surface of the jet panel, and the opening sizes of the surfaces of all the water outlet holes 31 on the same side surface of the water outlet panel 30 are not all equal.

The water outlet channel communicating with the water outlet hole 31 having the aforementioned area is located at the outer ring, the chamber 20 is a part of the water outlet channel, the inner ring is an inner ring water outlet channel 70, the additional inner ring water outlet channel 70 communicates with the outer space of the water outlet structure 100, the water inlets 60 of the two water outlet channels communicate with each other, and the water inlets 60 of the two water outlet channels can be selectively connected to the jet holes 11 on the jet panel 10 by rotating relative to the jet panel 10, so that air can be sucked from the additional inner ring water outlet channel.

In some embodiments, the sum of the opening areas of all the water outlet holes 31 on the water outlet side 32 surface of the water outlet panel is 2.5 times the sum of the opening areas of all the jet holes 11 on the water outlet side 13 surface of the jet panel, and the opening sizes of all the water outlet holes 31 on the same side surface of the water outlet panel 30 are not all equal.

In view of the above, the present disclosure provides a water outlet structure 100, a water outlet panel and an aerator with the panel, which can rapidly discharge water, avoid overflow caused by the pressure aggregation inside the aerator, and can form a dense water column with abundant flow volume and smooth water-air mixed flow, which is not prone to splashing when acting on cleaning surfaces, thereby providing excellent user experience.

What is claimed is:

1. A water outlet structure, comprising a water inlet and a water outlet in communication, the water inlet being provided with a plurality of water inlet openings, the water outlet being provided with a plurality of water outlet openings, a sum of areas of each of the water outlet openings being greater than a sum of areas of each of the water inlet openings.

2. The water outlet structure according to claim 1, wherein the water inlet is provided with a jet panel and the water outlet is provided with a water outlet panel, the water outlet structure further comprises a chamber,
the jet panel is provided with a plurality of jet holes, a water outlet side of the jet holes communicates with the chamber, a space of one side of the chamber which faces the water outlet direction is defined by the water outlet panel, and the water outlet panel is provided with a plurality of water outlet holes, and a sum of opening areas of each water outlet hole on the water outlet side surface of the water outlet panel is greater than a sum of opening areas of each jet hole on the water outlet side surface of the jet panel.

3. The water outlet structure according to claim 2, wherein the sum of the opening areas of all the water outlet holes on the water outlet side surface of the water outlet panel is greater than or equal to twice the sum of the opening areas of all the jet holes on the water outlet side surface of the jet panel.

4. The water outlet structure according to claim 2, wherein an opening area of each water outlet hole on the water inlet side surface of the water outlet panel is greater than an opening area of any of the water outlet holes on the water outlet side surface of the water outlet panel.

5. The water outlet structure according to claim 2, wherein an area of a single water outlet hole located on the water outlet side surface of the water outlet panel is from 0.04 mm² to 0.3 mm².

6. The water outlet structure according to claim 2, wherein an axial height distance of the water outlet hole is greater than a perimeter of an opening profile of the water outlet hole on a water outlet side surface of the water outlet panel.

7. The water outlet structure according to claim 6, wherein the axial height distance of the water outlet hole is greater than or equal to 1.5 times the perimeter of the opening profile of the water outlet hole on the water outlet side surface of the water outlet panel.

8. The water outlet structure according to claim 2, wherein a minimum separation distance between openings of any two adjacent water outlet holes on the water outlet side surface of the water outlet panel is greater than a diameter of a maximum inscribed circle of the opening profiles of the two water outlet holes on the water outlet side surface of the water outlet panel.

9. The water outlet structure according to claim 2, wherein the minimum separation distance between the openings of any two adjacent water outlet holes on the water inlet side surface of the water outlet panel is smaller than the diameter of the minimum inscribed circle of the opening profile of the two water outlet holes on the water outlet side surface of the water outlet panel.

10. The water outlet structure according to claim 9, wherein the minimum separation distance between the openings of any two adjacent water outlet holes on the water inlet side surface of the water outlet panel is smaller than or equal to 0.5 times the diameter of the minimum inscribed circle of the opening profile of the two water outlet holes on the water outlet side surface of the water outlet panel.

11. The water outlet structure according to claim 2, further comprising a screen mesh provided on the water inlet side of the water outlet panel, wherein the screen mesh is spaced apart from the water outlet panel, the screen mesh has a single mesh area smaller than the area of the opening profile of the water outlet hole on the water outlet side surface of the water outlet panel.

12. The water outlet structure according to claim 2, wherein the water outlet side of the jet hole bypasses the chamber and communicates with the outer space of the water outlet structure.

13. The water outlet structure according to claim 2, wherein the water outlet side of the jet hole communicates with an outer space of the water outlet structure via an air inlet, and the air inlet is located at either the water outlet side of the water outlet panel or a side wall of the water outlet structure.

14. The water outlet structure according to claim 1, further comprising a water outlet panel, wherein an opening area of the water outlet holes on the water inlet side surface of the water outlet panel is greater than the opening area of the water outlet holes on the water outlet side surface of the water outlet panel, a minimum separation distance between the openings of any two adjacent water outlet holes on the water inlet side surface of the water outlet panel is smaller than the diameter of a minimum inscribed circle of an opening profile of the water outlet holes on the water outlet side surface of the water outlet panel.

15. The water outlet structure according to claim 14, wherein the area of a single water outlet hole on the water outlet side surface of the water outlet panel is from 0.04 mm² to 0.3 mm².

16. The water outlet structure according to claim 14, wherein an axial height distance of the water outlet hole is greater than a perimeter of an opening profile of the water outlet hole on a water outlet side surface of the water outlet panel.

17. The water outlet structure according to claim 16, wherein the axial height distance of the water outlet hole is greater than or equal to 1.5 times the perimeter of the opening profile of the water outlet hole on the water outlet side surface of the water outlet panel.

18. The water outlet structure according to claim 14, wherein a minimum separation distance between openings of any two adjacent water outlet holes on the water outlet side surface of the water outlet panel is greater than a diameter of a maximum inscribed circle of the opening profiles of the two water outlet holes on the water outlet side surface of the water outlet panel.

19. The water outlet structure according to claim 18, wherein the minimum separation distance between openings of any two adjacent water outlet holes on the water outlet side surface of the water outlet panel is greater than or equal to 1.5 times the diameter of the maximum inscribed circle of the opening profile of the two water outlet holes on the water outlet side surface of the water outlet panel.

20. The water outlet structure according to claim 14, wherein the minimum separation distance between openings of any two adjacent water outlet holes on the water inlet side surface of the water outlet panel is smaller than or equal to 0.5 times the diameter of the minimum inscribed circle of the opening profile of the two water outlet holes on the water outlet side surface of the water outlet panel.
